(19) United States
(12) Patent Application Publication
(10) Pub. No.: US 2026/0111902 A1
(43) Pub. Date: Apr. 23, 2026

(54) SYSTEM

(71) Applicant: SoftBank Group Corp., Tokyo (JP)

(72) Inventor: Fumio TSURUDA, Tokyo (JP)

(21) Appl. No.: 19/354,096

(22) Filed: Oct. 9, 2025

(30) Foreign Application Priority Data
Oct. 18, 2024 (JP) 2024-183977

(51) Int. Cl. G06Q 30/01; G06Q 10/10; G10L 15/183; G10L 21/0208; G10L 25/63

(52) U.S. Cl. CPC G06Q 30/01; G06Q 10/10; G10L 15/183; G10L 21/0208; G10L 25/63

(57) ABSTRACT

The system according to the embodiment includes a reading unit, an analysis unit, a matching unit, a warning unit, and a customer service reading unit. The reading unit reads the content of conversations with customers. The analysis unit analyzes the conversation content read by the reading unit. The matching unit compares the PC screen information registered by crew members. The warning unit issues a warning when a difference occurs based on the information matched by the matching unit. The customer service reading unit reads the content of customer service at the storefront.

### CROSS-REFERENCE TO RELATED APPLICATION

The present application claims priority to and incorporates by reference the entire contents of Japanese Patent Application No. 2024-183977 filed in Japan on Oct. 18, 2024.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, including: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there is a lack of effective means to prevent erroneous registration or mistakes in customer service, and there is room for improvement.

### SUMMARY OF THE INVENTION

The system according to the embodiment includes a reading unit, an analysis unit, a matching unit, a warning unit, and a customer service reading unit. The reading unit reads the content of conversations with customers. The analysis unit analyzes the conversation content read by the reading unit. The matching unit compares the PC screen information registered by crew members. The warning unit issues a warning when a difference occurs based on the information matched by the matching unit. The customer service reading unit reads the content of customer service at the storefront.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor with a sign (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) with a sign is a memory where information is temporarily stored and used as a work memory by the processor.

In the following embodiments, a storage with a sign is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) with a sign is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,”the same concept as “A and/or B”applies.

### First Embodiment

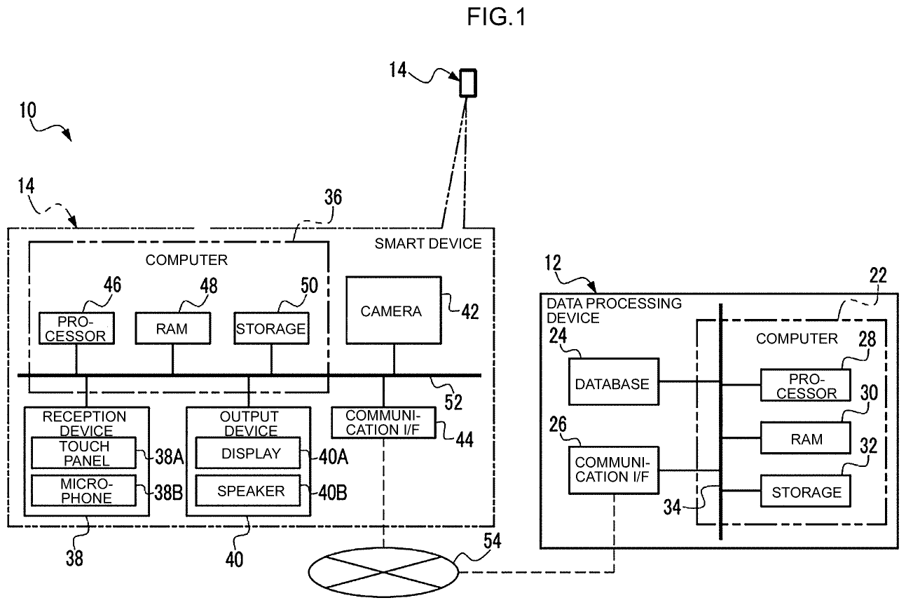

FIG. 1 shows an example configuration of a data processing system 10 according to the first embodiment.

As shown in FIG. 1, the data processing system 10 includes a data processing device 12 and a smart device 14. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 includes a computer 36, a reception device 38, an output device 40, a camera 42, and a communication I/F 44. The computer 36 includes a processor 46, RAM 48, and storage 50. The processor 46, RAM 48, and storage 50 are connected to a bus 52. The reception device 38, output device 40, and camera 42 are also connected to the bus 52.

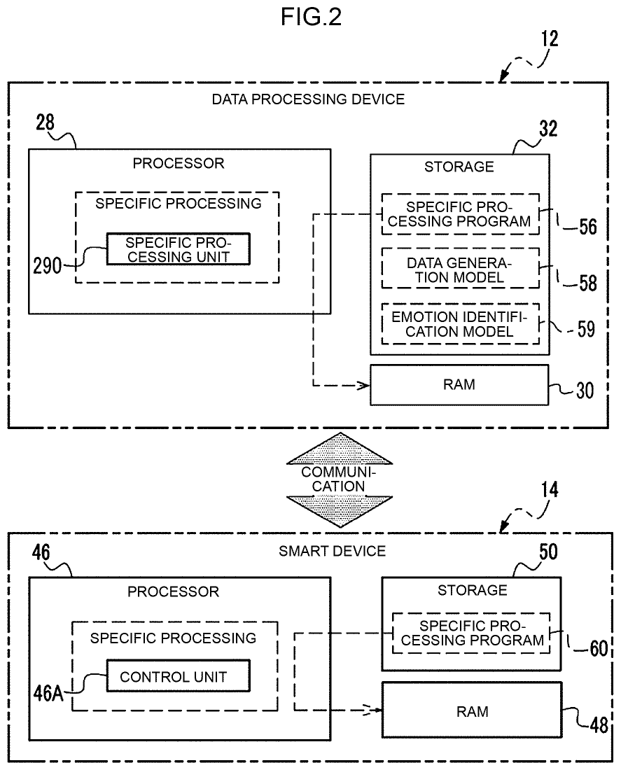

The reception device 38 includes a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 includes a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1 of Embodiment

The information accident prevention system according to the embodiment of the present invention is a mechanism that utilizes AI to prevent information accidents during customer service. This information accident prevention system first has AI read the content of conversations with customers. Next, the AI compares the PC screen information registered by crew members. If there is a difference between the conversation information and the registered content, the AI issues a warning. This prevents mistakes and reduces information accidents. For example, if customer A says, “I am moving, so please change my address from Tokyo to Fukuoka,” the AI reads the conversation content and compares it with the PC screen information registered by the crew. If the crew attempts to register the information of customer B by mistake, the AI issues a warning and prevents the mistake. With this mechanism, AI automatically checks the content and prevents mistakes without relying on manual double-checks. As a result, information accidents are reduced, and the time required for recovery and countermeasures is also reduced. In addition, it can be used for customer service at the storefront, and similar accidents can be prevented. Thus, the information accident prevention system can prevent information accidents during customer service and reduce mistakes.

The information accident prevention system according to the embodiment includes a reading unit, an analysis unit, a matching unit, a warning unit, and a customer service reading unit. The reading unit reads the content of conversations with customers. The reading unit can read, for example, the content of voice calls, video calls, or text chats. The analysis unit analyzes the conversation content read by the reading unit. The analysis unit can analyze the conversation content by methods such as speech recognition, emotion analysis, or keyword extraction. The matching unit compares the PC screen information registered by crew members. The matching unit can perform matching based on criteria such as matching rate or similarity calculation with a database. The warning unit issues a warning when a difference occurs based on the information matched by the matching unit. The warning unit can display warnings by methods such as pop-up notifications or voice alerts. The customer service reading unit reads the content of customer service at the storefront. The customer service reading unit can read, for example, the content of face-to-face service, online service, or chat support. Thus, the information accident prevention system according to the embodiment can prevent information accidents during customer service and reduce mistakes.

The reading unit reads the content of conversations with customers. The reading unit can read, for example, the content of voice calls, video calls, or text chats.

Specifically, in the case of voice calls, audio data is acquired through a microphone; in the case of video calls, video and audio data are acquired through a camera and microphone; and in the case of text chats, chat logs are acquired and stored in real time. These data are transmitted and stored on a central server using a secure communication protocol. The reading unit can use noise-canceling technology to remove background noise and improve the clarity of the conversation content. In addition, audio data is converted into text data by a speech recognition engine, making it easier to process in the analysis unit. In the case of video calls, video data is pre-processed using facial recognition technology to analyze the customer's facial expressions and movements. In the case of text chats, natural language processing technology is used to understand the context and extract important keywords and phrases. In this way, the reading unit can handle various conversation formats and collect data accurately and efficiently. Furthermore, by adjusting the frequency and accuracy of data collection, the reading unit can flexibly respond to specific situations and conditions. For example, when important conversations or specific keywords are detected, the frequency of collection can be increased to obtain more detailed data. Thus, the reading unit can efficiently and effectively collect data and improve the overall performance of the system.

The analysis unit analyzes the conversation content read by the reading unit. The analysis unit can analyze the conversation content by methods such as speech recognition, emotion analysis, or keyword extraction. Specifically, speech recognition technology is used to convert audio data into text data, and natural language processing technology is used to analyze the text data. In emotion analysis, the customer's emotional state is estimated based on the tone and speed of the voice and the context of the text. For example, if the tone of the voice is high and the speed is fast, it may indicate anger or excitement. In keyword extraction, important keywords and phrases set in advance are detected to grasp the main points of the conversation content. In this way, the analysis unit can perform detailed analysis of the conversation content and extract important information. Furthermore, the analysis unit can improve analysis accuracy based on past data using machine learning algorithms. For example, by learning from past conversation data and detecting specific patterns or trends, it is possible to predict future conversation content or assess risks. In addition, the analysis unit can use anomaly detection algorithms to detect unusual patterns or abnormal data and issue early warnings. Thus, the analysis unit can not only grasp the real-time situation but also handle long-term risk management and anomaly detection, thereby improving the reliability and safety of the entire system.

The matching unit compares the PC screen information registered by crew members. The matching unit can perform matching based on criteria such as matching rate or similarity calculation with a database. Specifically, the matching unit acquires screenshots or operation logs of the PC screen operated by the crew and compares them with the correct information stored in the database. Image recognition technology or text mining technology is used for matching to analyze the information on the screen and calculate the matching rate or similarity. For example, the matching unit checks whether the customer information entered by the crew matches the information in the database and issues a warning if there is a mismatch. In addition, the operation logs can be analyzed to detect unauthorized operations or abnormal patterns. In this way, the matching unit can monitor the crew's operations in real time and ensure the accuracy of information. Furthermore, the matching unit can dynamically adjust the matching criteria based on past data. For example, if input errors frequently occur during certain time periods or situations, the matching criteria can be set according to those periods or situations to improve accuracy. In addition, the matching unit can use anomaly detection algorithms to detect unusual patterns or abnormal data and issue early warnings. Thus, the matching unit can not only grasp the real-time situation but also handle long-term risk management and anomaly detection, thereby improving the reliability and safety of the entire system.

The warning unit issues a warning when a difference occurs based on the information matched by the matching unit. The warning unit can display warnings by methods such as pop-up notifications or voice alerts. Specifically, a pop-up notification is displayed on the crew's PC screen to draw attention. In addition, a voice alert can be used to immediately notify the crew of the warning. Furthermore, the warning unit records the details of the warning for later confirmation. For example, the date and time of the warning, the content, and the response status are recorded in a log so that the administrator can check them later. In this way, the warning unit can issue warnings to the crew in real time and prevent information accidents.

Furthermore, the warning unit can dynamically adjust the frequency and content of warnings. For example, if warnings frequently occur for a particular crew member or situation, the warning criteria can be set according to that crew member or situation to improve accuracy. In addition, the warning unit can collect user feedback and continuously improve the accuracy and effectiveness of the warning content. For example, the warning content can be reviewed and improved based on feedback from crew members who received the warning. Thus, the warning unit can provide warnings to users quickly and reliably and minimize information accidents.

The customer service reading unit reads the content of customer service at the storefront. The customer service reading unit can read, for example, the content of face-to-face service, online service, or chat support. Specifically, in the case of face-to-face service, audio and video data are acquired using a microphone and camera; in the case of online service, audio and video data are acquired through a video call system; and in the case of chat support, chat logs are acquired and stored in real time. These data are transmitted and stored on a central server using a secure communication protocol. The customer service reading unit can use noise-canceling technology to remove background noise and improve the clarity of the customer service content. In addition, audio data is converted into text data by a speech recognition engine, making it easier to process in the analysis unit. Video data is pre-processed using facial recognition technology to analyze the customer's facial expressions and movements. In the case of chat support, natural language processing technology is used to understand the context and extract important keywords and phrases. In this way, the customer service reading unit can handle various customer service formats and collect data accurately and efficiently.

Furthermore, by adjusting the frequency and accuracy of data collection, the customer service reading unit can flexibly respond to specific situations and conditions. For example, when important conversations or specific keywords are detected, the frequency of collection can be increased to obtain more detailed data. Thus, the customer service reading unit can efficiently and effectively collect data and improve the overall performance of the system.

The reading unit may be provided with a filtering function to remove background sounds and noise when reading the conversation content. For example, the reading unit analyzes background sounds occurring during a call in real time, and AI removes noise to clearly read the conversation content. In addition, the reading unit may filter noise in specific frequency bands when reading the conversation content, allowing AI to extract important audio information. Furthermore, the reading unit may have AI learn environmental sounds and automatically remove specific noise patterns when reading the conversation content. By removing background sounds and noise in this way, the conversation content can be read clearly. Some or all of the above-described processing in the reading unit may be performed using AI or without using AI. For example, the reading unit may input audio data during a call to a generative AI and have the generative AI perform noise removal.

The reading unit may be provided with a function to emphasize and read specific keywords or phrases when reading the conversation content. For example, the reading unit may have AI automatically detect important keywords in the conversation content and emphasize them when reading. In addition, the reading unit may have AI preferentially extract specific phrases and emphasize them according to their importance when reading the conversation content. Furthermore, the reading unit may have AI emphasize important information based on a preset keyword list when reading the conversation content. By emphasizing and reading important keywords or phrases in this way, important information is not overlooked. Some or all of the above-described processing in the reading unit may be performed using AI or without using AI. For example, the reading unit may input audio data of the conversation content to a generative AI and have the generative AI perform the emphasis of keywords or phrases.

The reading unit may be provided with a function to automatically record the start time and end time of the conversation when reading the conversation content. For example, the reading unit may have AI automatically record the start time at the moment the call begins. In addition, the reading unit may have AI automatically record the end time when the call ends and calculate the total call duration. Furthermore, the reading unit may have AI record the start and end times of the call in real time when reading the conversation content so that they can be referenced later. By automatically recording the start and end times of the call in this way, the total call duration can be accurately grasped. Some or all of the above-described processing in the reading unit may be performed using AI or without using AI. For example, the reading unit may input the start and end times of the call to a generative AI and have the generative AI perform the recording.

The reading unit may be provided with a function to convert the content of the conversation into text in real time when reading the conversation content. For example, the reading unit may have AI convert the conversation content into text in real time and display it immediately. In addition, the reading unit may have AI convert speech into text and record it in real time when reading the conversation content. Furthermore, the reading unit may have AI use speech recognition technology to convert the conversation content into text in real time when reading the conversation content. By converting the conversation content into text in real time in this way, the content can be checked immediately. Some or all of the above-described processing in the reading unit may be performed using AI or without using AI. For example, the reading unit may input audio data of the conversation content to a generative AI and have the generative AI perform the text conversion.

The analysis unit may be provided with a function to improve analysis accuracy by considering the context of the conversation content during analysis. For example, the analysis unit may have AI analyze the context of the conversation content and extract important information. In addition, the analysis unit may have AI improve the accuracy of analysis results by considering the context of the conversation content. Furthermore, the analysis unit may have AI understand the context of the conversation content and accurately analyze related information. By considering the context of the conversation content in this way, analysis accuracy is improved. Some or all of the above-described processing in the analysis unit may be performed using AI or without using AI. For example, the analysis unit may input text data of the conversation content to a generative AI and have the generative AI perform context analysis.

The analysis unit may be provided with a function to apply different analysis algorithms according to the category of the conversation content during analysis. For example, if the conversation content is related to complaint handling, the analysis unit may have AI apply a specific analysis algorithm. In addition, if the conversation content is related to inquiry handling, the analysis unit may have AI apply a different analysis algorithm. Furthermore, if the conversation content is related to order reception, the analysis unit may have AI select and apply an appropriate analysis algorithm. By applying appropriate analysis algorithms according to the category of the conversation content in this way, analysis accuracy is improved. Some or all of the above-described processing in the analysis unit may be performed using AI or without using AI. For example, the analysis unit may input text data of the conversation content to a generative AI and have the generative AI perform category-based analysis.

The analysis unit may be provided with a function to adjust the level of detail of the analysis based on the length of the conversation content during analysis. For example, if the conversation content is short, the analysis unit may have AI perform detailed analysis and extract important information. In addition, if the conversation content is long, the analysis unit may have AI perform an overall analysis and summarize the main points. Furthermore, the analysis unit may have AI adjust the level of detail of the analysis according to the length of the conversation content and provide appropriate information. By adjusting the level of detail of the analysis according to the length of the conversation content in this way, appropriate information can be provided. Some or all of the above-described processing in the analysis unit may be performed using AI or without using AI. For example, the analysis unit may input text data of the conversation content to a generative AI and have the generative AI perform length-based analysis.

The analysis unit may be provided with a function to adjust the order of analysis results based on the relevance of the conversation content during analysis. For example, the analysis unit may have AI analyze the relevance of the conversation content and display important information preferentially. In addition, the analysis unit may have AI adjust the order of analysis results based on the relevance of the conversation content. Furthermore, the analysis unit may have AI understand the relevance of the conversation content and display analysis results in an appropriate order. By adjusting the order of analysis results based on the relevance of the conversation content in this way, important information can be provided preferentially. Some or all of the above-described processing in the analysis unit may be performed using AI or without using AI. For example, the analysis unit may input text data of the conversation content to a generative AI and have the generative AI perform relevance-based analysis.

The matching unit may be provided with a function to improve matching accuracy by considering the change history of PC screen information during matching. For example, the matching unit may have AI analyze the change history of PC screen information and improve matching accuracy. In addition, the matching unit may have AI consider the change history of PC screen information during matching and perform accurate matching. Furthermore, the matching unit may have AI learn the change history of PC screen information and improve matching accuracy. By considering the change history of PC screen information in this way, matching accuracy is improved. Some or all of the above-described processing in the matching unit may be performed using AI or without using AI. For example, the matching unit may input change history data of PC screen information to a generative AI and have the generative AI perform matching accuracy improvement.

The matching unit may be provided with a function to apply different matching algorithms according to the category of PC screen information during matching. For example, if the PC screen information is customer information, the matching unit may have AI apply a specific matching algorithm. In addition, if the PC screen information is order information, the matching unit may have AI apply a different matching algorithm. Furthermore, if the PC screen information is inquiry information, the matching unit may have AI select and apply an appropriate matching algorithm. By applying appropriate matching algorithms according to the category of PC screen information in this way, matching accuracy is improved. Some or all of the above-described processing in the matching unit may be performed using AI or without using AI. For example, the matching unit may input data of PC screen information to a generative AI and have the generative AI perform category-based matching.

The matching unit may be provided with a function to determine the priority of matching based on the update frequency of PC screen information during matching. For example, the matching unit may have AI analyze the update frequency of PC screen information and determine the priority of matching. In addition, the matching unit may have AI consider the update frequency of PC screen information during matching and preferentially match important information. Furthermore, the matching unit may have AI adjust the priority of matching based on the update frequency of PC screen information. By determining the priority of matching based on the update frequency of PC screen information in this way, important information can be preferentially matched. Some or all of the above-described processing in the matching unit may be performed using AI or without using AI. For example, the matching unit may input update frequency data of PC screen information to a generative AI and have the generative AI perform priority determination.

The matching unit may be provided with a function to adjust the order of matching results based on the relevance of PC screen information during matching. For example, the matching unit may have AI analyze the relevance of PC screen information and preferentially match important information. In addition, the matching unit may have AI consider the relevance of PC screen information during matching and adjust the order of matching results. Furthermore, the matching unit may have AI display matching results in an appropriate order based on the relevance of PC screen information. By adjusting the order of matching results based on the relevance of PC screen information in this way, important information can be displayed preferentially. Some or all of the above-described processing in the matching unit may be performed using AI or without using AI. For example, the matching unit may input relevance data of PC screen information to a generative AI and have the generative AI perform order adjustment.

The warning unit may be provided with a function to improve the accuracy of warnings by referring to past warning histories during warning. For example, the warning unit may have AI analyze past warning histories and improve the accuracy of warnings. In addition, the warning unit may have AI refer to past warning histories during warning and issue accurate warnings. Furthermore, the warning unit may have AI learn past warning histories and improve the accuracy of warnings. By referring to past warning histories in this way, the accuracy of warnings is improved. Some or all of the above-described processing in the warning unit may be performed using AI or without using AI. For example, the warning unit may input past warning history data to a generative AI and have the generative AI perform accuracy improvement.

The warning unit may be provided with a function to apply different warning means according to the importance of the warning during warning. For example, in the case of a highly important warning, the warning unit may have AI issue both audio and visual warnings simultaneously. In addition, in the case of a less important warning, the warning unit may have AI issue only a visual warning. Furthermore, the warning unit may have AI select appropriate warning means according to the importance and issue warnings. By selecting appropriate warning means according to the importance of the warning in this way, effective warnings can be provided. Some or all of the above-described processing in the warning unit may be performed using AI or without using AI. For example, the warning unit may input importance data of the warning to a generative AI and have the generative AI perform means selection.

The warning unit may be provided with a function to adjust the display order of warnings based on the frequency of warning occurrences during warning. For example, the warning unit may have AI analyze the frequency of warning occurrences and preferentially display important warnings. In addition, the warning unit may have AI consider the frequency of warning occurrences during warning and preferentially display important information. Furthermore, the warning unit may have AI adjust the display order of warnings based on the frequency of warning occurrences. By adjusting the display order of warnings based on the frequency of warning occurrences in this way, important information can be displayed preferentially. Some or all of the above-described processing in the warning unit may be performed using AI or without using AI. For example, the warning unit may input frequency data of warning occurrences to a generative AI and have the generative AI perform order adjustment.

The warning unit may be provided with a function to adjust the order of warning contents based on the relevance of warnings during warning. For example, the warning unit may have AI analyze the relevance of warnings and preferentially display important information. In addition, the warning unit may have AI consider the relevance of warnings during warning and adjust the order of warning contents. Furthermore, the warning unit may have AI display warning contents in an appropriate order based on the relevance of warnings. By adjusting the order of warning contents based on the relevance of warnings in this way, important information can be displayed preferentially. Some or all of the above-described processing in the warning unit may be performed using AI or without using AI. For example, the warning unit may input relevance data of warnings to a generative AI and have the generative AI perform order adjustment.

The customer service reading unit may be provided with a filtering function to remove background sounds and noise when reading customer service content. For example, the customer service reading unit analyzes background sounds occurring during customer service in real time, and AI removes noise to clearly read the customer service content. In addition, the customer service reading unit may filter noise in specific frequency bands when reading customer service content, allowing AI to extract important audio information. Furthermore, the customer service reading unit may have AI learn environmental sounds and automatically remove specific noise patterns when reading customer service content. By removing background sounds and noise in this way, the customer service content can be read clearly. Some or all of the above-described processing in the customer service reading unit may be performed using AI or without using AI. For example, the customer service reading unit may input audio data during customer service to a generative AI and have the generative AI perform noise removal.

The customer service reading unit may be provided with a function to emphasize and read specific keywords or phrases when reading customer service content. For example, the customer service reading unit may have AI automatically detect important keywords in the customer service content and emphasize them when reading. In addition, the customer service reading unit may have AI preferentially extract specific phrases and emphasize them according to their importance when reading customer service content. Furthermore, the customer service reading unit may have AI emphasize important information based on a preset keyword list when reading customer service content. By emphasizing and reading important keywords or phrases in this way, important information is not overlooked. Some or all of the above-described processing in the customer service reading unit may be performed using AI or without using AI. For example, the customer service reading unit may input audio data of the customer service content to a generative AI and have the generative AI perform the emphasis of keywords or phrases.

The customer service reading unit may be provided with a function to automatically record the start time and end time of customer service when reading customer service content. For example, the customer service reading unit may have AI automatically record the start time at the moment customer service begins. In addition, the customer service reading unit may have AI automatically record the end time when customer service ends and calculate the total customer service duration. Furthermore, the customer service reading unit may have AI record the start and end times of customer service in real time when reading customer service content so that they can be referenced later. By automatically recording the start and end times of customer service in this way, the total customer service duration can be accurately grasped. Some or all of the above-described processing in the customer service reading unit may be performed using AI or without using AI. For example, the customer service reading unit may input the start and end times of customer service to a generative AI and have the generative AI perform the recording.

The customer service reading unit may be provided with a function to convert the content of customer service into text in real time when reading customer service content. For example, the customer service reading unit may have AI convert the customer service content into text in real time and display it immediately. In addition, the customer service reading unit may have AI convert speech into text and record it in real time when reading customer service content. Furthermore, the customer service reading unit may have AI use speech recognition technology to convert the customer service content into text in real time when reading customer service content. By converting the customer service content into text in real time in this way, the content can be checked immediately. Some or all of the above-described processing in the customer service reading unit may be performed using AI or without using AI. For example, the customer service reading unit may input audio data of the customer service content to a generative AI and have the generative AI perform the text conversion.

The system according to the embodiment is not limited to the above-described examples and can be variously modified as follows, for example.

The analysis unit may improve analysis accuracy by considering the context of the conversation content during analysis. For example, the analysis unit may have AI analyze the context of the conversation content and extract important information. In addition, the analysis unit may have AI improve the accuracy of analysis results by considering the context of the conversation content. Furthermore, the analysis unit may have AI understand the context of the conversation content and accurately analyze related information. By considering the context of the conversation content in this way, analysis accuracy is improved. Some or all of the above-described processing in the analysis unit may be performed using AI or without using AI. For example, the analysis unit may input text data of the conversation content to a generative AI and have the generative AI perform context analysis.

The warning unit may improve the accuracy of warnings by referring to past warning histories during warning. For example, the warning unit may have AI analyze past warning histories and improve the accuracy of warnings. In addition, the warning unit may have AI refer to past warning histories during warning and issue accurate warnings. Furthermore, the warning unit may have AI learn past warning histories and improve the accuracy of warnings. By referring to past warning histories in this way, the accuracy of warnings is improved. Some or all of the above-described processing in the warning unit may be performed using AI or without using AI. For example, the warning unit may input past warning history data to a generative AI and have the generative AI perform accuracy improvement.

The matching unit may improve matching accuracy by considering the change history of PC screen information during matching. For example, the matching unit may have AI analyze the change history of PC screen information and improve matching accuracy. In addition, the matching unit may have AI consider the change history of PC screen information during matching and perform accurate matching. Furthermore, the matching unit may have AI learn the change history of PC screen information and improve matching accuracy. By considering the change history of PC screen information in this way, matching accuracy is improved. Some or all of the above-described processing in the matching unit may be performed using AI or without using AI. For example, the matching unit may input change history data of PC screen information to a generative AI and have the generative AI perform matching accuracy improvement.

The reading unit may be provided with a filtering function to remove background sounds and noise when reading the conversation content. For example, the reading unit analyzes background sounds occurring during a call in real time, and AI removes noise to clearly read the conversation content. In addition, the reading unit may filter noise in specific frequency bands when reading the conversation content, allowing AI to extract important audio information. Furthermore, the reading unit may have AI learn environmental sounds and automatically remove specific noise patterns when reading the conversation content. By removing background sounds and noise in this way, the conversation content can be read clearly. Some or all of the above-described processing in the reading unit may be performed using AI or without using AI. For example, the reading unit may input audio data during a call to a generative AI and have the generative AI perform noise removal.

The analysis unit may adjust the level of detail of the analysis based on the length of the conversation content during analysis. For example, if the conversation content is short, the analysis unit may have AI perform detailed analysis and extract important information. In addition, if the conversation content is long, the analysis unit may have AI perform an overall analysis and summarize the main points. Furthermore, the analysis unit may have AI adjust the level of detail of the analysis according to the length of the conversation content and provide appropriate information. By adjusting the level of detail of the analysis according to the length of the conversation content in this way, appropriate information can be provided. Some or all of the above-described processing in the analysis unit may be performed using AI or without using AI. For example, the analysis unit may input text data of the conversation content to a generative AI and have the generative AI perform length-based analysis.

A brief description of the processing flow of Example 1 of the Embodiment is provided below.

Step 1: The reading unit reads the content of conversations with customers. The reading unit can read, for example, the content of voice calls, video calls, or text chats. Step 2: The analysis unit analyzes the conversation content read by the reading unit. The analysis unit can analyze the conversation content by methods such as speech recognition, emotion analysis, or keyword extraction. Step 3: The matching unit compares the PC screen information registered by crew members. The matching unit can perform matching based on criteria such as matching rate or similarity calculation with a database.

Step 4: The warning unit issues a warning when a difference occurs based on the information matched by the matching unit. The warning unit can display warnings by methods such as pop-up notifications or voice alerts. Step 5: The customer service reading unit reads the content of customer service at the storefront. The customer service reading unit can read, for example, the content of face-to-face service, online service, or chat support.

### Example 2 of Embodiment

The information accident prevention system according to the embodiment of the present invention is a mechanism that utilizes AI to prevent information accidents during customer service. This information accident prevention system first has AI read the content of conversations with customers. Next, the AI compares the PC screen information registered by crew members. If there is a difference between the conversation information and the registered content, the AI issues a warning. This prevents mistakes and reduces information accidents. For example, if customer A says, “I am moving, so please change my address from Tokyo to Fukuoka,” the AI reads the conversation content and compares it with the PC screen information registered by the crew. If the crew attempts to register the information of customer B by mistake, the AI issues a warning and prevents the mistake. With this mechanism, AI automatically checks the content and prevents mistakes without relying on manual double-checks. As a result, information accidents are reduced, and the time required for recovery and countermeasures is also reduced. In addition, it can be used for customer service at the storefront, and similar accidents can be prevented. Thus, the information accident prevention system can prevent information accidents during customer service and reduce mistakes.

The information accident prevention system according to the embodiment includes a reading unit, an analysis unit, a matching unit, a warning unit, and a customer service reading unit. The reading unit reads the content of conversations with customers. The reading unit can read, for example, the content of voice calls, video calls, or text chats. The analysis unit analyzes the conversation content read by the reading unit. The analysis unit can analyze the conversation content by methods such as speech recognition, emotion analysis, or keyword extraction. The matching unit compares the PC screen information registered by crew members. The matching unit can perform matching based on criteria such as matching rate or similarity calculation with a database. The warning unit issues a warning when a difference occurs based on the information matched by the matching unit. The warning unit can display warnings by methods such as pop-up notifications or voice alerts. The customer service reading unit reads the content of customer service at the storefront. The customer service reading unit can read, for example, the content of face-to-face service, online service, or chat support. Thus, the information accident prevention system according to the embodiment can prevent information accidents during customer service and reduce mistakes.

The reading unit reads the content of conversations with customers. The reading unit can read, for example, the content of voice calls, video calls, or text chats.

Specifically, in the case of voice calls, audio data is acquired through a microphone; in the case of video calls, video and audio data are acquired through a camera and microphone; and in the case of text chats, chat logs are acquired and stored in real time. These data are transmitted and stored on a central server using a secure communication protocol. The reading unit can use noise-canceling technology to remove background noise and improve the clarity of the conversation content. In addition, audio data is converted into text data by a speech recognition engine, making it easier to process in the analysis unit. In the case of video calls, video data is pre-processed using facial recognition technology to analyze the customer's facial expressions and movements. In the case of text chats, natural language processing technology is used to understand the context and extract important keywords and phrases. In this way, the reading unit can handle various conversation formats and collect data accurately and efficiently. Furthermore, by adjusting the frequency and accuracy of data collection, the reading unit can flexibly respond to specific situations and conditions. For example, when important conversations or specific keywords are detected, the frequency of collection can be increased to obtain more detailed data. Thus, the reading unit can efficiently and effectively collect data and improve the overall performance of the system.

The analysis unit analyzes the conversation content read by the reading unit. The analysis unit can analyze the conversation content by methods such as speech recognition, emotion analysis, or keyword extraction. Specifically, speech recognition technology is used to convert audio data into text data, and natural language processing technology is used to analyze the text data. In emotion analysis, the customer's emotional state is estimated based on the tone and speed of the voice and the context of the text. For example, if the tone of the voice is high and the speed is fast, it may indicate anger or excitement. In keyword extraction, important keywords and phrases set in advance are detected to grasp the main points of the conversation content. In this way, the analysis unit can perform detailed analysis of the conversation content and extract important information. Furthermore, the analysis unit can improve analysis accuracy based on past data using machine learning algorithms. For example, by learning from past conversation data and detecting specific patterns or trends, it is possible to predict future conversation content or assess risks. In addition, the analysis unit can use anomaly detection algorithms to detect unusual patterns or abnormal data and issue early warnings. Thus, the analysis unit can not only grasp the real-time situation but also handle long-term risk management and anomaly detection, thereby improving the reliability and safety of the entire system.

The matching unit compares the PC screen information registered by crew members. The matching unit can perform matching based on criteria such as matching rate or similarity calculation with a database. Specifically, the matching unit acquires screenshots or operation logs of the PC screen operated by the crew and compares them with the correct information stored in the database. Image recognition technology or text mining technology is used for matching to analyze the information on the screen and calculate the matching rate or similarity. For example, the matching unit checks whether the customer information entered by the crew matches the information in the database and issues a warning if there is a mismatch. In addition, the operation logs can be analyzed to detect unauthorized operations or abnormal patterns. In this way, the matching unit can monitor the crew's operations in real time and ensure the accuracy of information. Furthermore, the matching unit can dynamically adjust the matching criteria based on past data. For example, if input errors frequently occur during certain time periods or situations, the matching criteria can be set according to those periods or situations to improve accuracy. In addition, the matching unit can use anomaly detection algorithms to detect unusual patterns or abnormal data and issue early warnings. Thus, the matching unit can not only grasp the real-time situation but also handle long-term risk management and anomaly detection, thereby improving the reliability and safety of the entire system.

The warning unit issues a warning when a difference occurs based on the information matched by the matching unit. The warning unit can display warnings by methods such as pop-up notifications or voice alerts. Specifically, a pop-up notification is displayed on the crew's PC screen to draw attention. In addition, a voice alert can be used to immediately notify the crew of the warning. Furthermore, the warning unit records the details of the warning for later confirmation. For example, the date and time of the warning, the content, and the response status are recorded in a log so that the administrator can check them later. In this way, the warning unit can issue warnings to the crew in real time and prevent information accidents. Furthermore, the warning unit can dynamically adjust the frequency and content of warnings. For example, if warnings frequently occur for a particular crew member or situation, the warning criteria can be set according to that crew member or situation to improve accuracy. In addition, the warning unit can collect user feedback and continuously improve the accuracy and effectiveness of the warning content. For example, the warning content can be reviewed and improved based on feedback from crew members who received the warning. Thus, the warning unit can provide warnings to users quickly and reliably and minimize information accidents.

The customer service reading unit reads the content of customer service at the storefront. The customer service reading unit can read, for example, the content of face-to-face service, online service, or chat support. Specifically, in the case of face-to-face service, audio and video data are acquired using a microphone and camera; in the case of online service, audio and video data are acquired through a video call system; and in the case of chat support, chat logs are acquired and stored in real time. These data are transmitted and stored on a central server using a secure communication protocol. The customer service reading unit can use noise-canceling technology to remove background noise and improve the clarity of the customer service content. In addition, audio data is converted into text data by a speech recognition engine, making it easier to process in the analysis unit. Video data is pre-processed using facial recognition technology to analyze the customer's facial expressions and movements. In the case of chat support, natural language processing technology is used to understand the context and extract important keywords and phrases. In this way, the customer service reading unit can handle various customer service formats and collect data accurately and efficiently. Furthermore, by adjusting the frequency and accuracy of data collection, the customer service reading unit can flexibly respond to specific situations and conditions. For example, when important conversations or specific keywords are detected, the frequency of collection can be increased to obtain more detailed data. Thus, the customer service reading unit can efficiently and effectively collect data and improve the overall performance of the system.

The reading unit may estimate the customer's emotion and adjust the reading accuracy of the conversation content based on the estimated emotion of the customer. For example, if the customer is nervous, AI may adjust the tone and speed of the voice to improve the reading accuracy of the conversation content. If the customer is relaxed, AI may focus on the natural flow of conversation while maintaining the reading accuracy of the conversation content. In addition, if the customer is in a hurry, AI may adjust to prioritize reading important parts of the conversation content. By adjusting the reading accuracy of the conversation content according to the customer's emotion in this way, more accurate information can be obtained. Emotion estimation is realized, for example, by using an emotion engine or a generative AI with an emotion estimation function. The generative AI may be a text generative AI (e.g., LLM) or a multimodal generative AI, but is not limited to such examples. Some or all of the above-described processing in the reading unit may be performed using AI or without using AI. For example, the reading unit may input the customer's audio data to a generative AI and have the generative AI perform emotion estimation.

The reading unit may be provided with a filtering function to remove background sounds and noise when reading the conversation content. For example, the reading unit analyzes background sounds occurring during a call in real time, and AI removes noise to clearly read the conversation content. In addition, the reading unit may filter noise in specific frequency bands when reading the conversation content, allowing AI to extract important audio information. Furthermore, the reading unit may have AI learn environmental sounds and automatically remove specific noise patterns when reading the conversation content. By removing background sounds and noise in this way, the conversation content can be read clearly. Some or all of the above-described processing in the reading unit may be performed using AI or without using AI. For example, the reading unit may input audio data during a call to a generative AI and have the generative AI perform noise removal.

The reading unit may be provided with a function to emphasize and read specific keywords or phrases when reading the conversation content. For example, the reading unit may have AI automatically detect important keywords in the conversation content and emphasize them when reading. In addition, the reading unit may have AI preferentially extract specific phrases and emphasize them according to their importance when reading the conversation content. Furthermore, the reading unit may have AI emphasize important information based on a preset keyword list when reading the conversation content. By emphasizing and reading important keywords or phrases in this way, important information is not overlooked. Some or all of the above-described processing in the reading unit may be performed using AI or without using AI. For example, the reading unit may input audio data of the conversation content to a generative AI and have the generative AI perform the emphasis of keywords or phrases.

The reading unit may estimate the customer's emotion and determine the priority of the conversation content to be read based on the estimated emotion of the customer. For example, if the customer is feeling anxious, AI may prioritize reading important conversation content based on that emotion. If the customer is excited, AI may prioritize reading the calm parts of the conversation content based on that emotion. In addition, if the customer is calm, AI may read the entire conversation content evenly based on that emotion. By determining the priority of the conversation content according to the customer's emotion in this way, important information can be preferentially obtained. Emotion estimation is realized, for example, by using an emotion engine or a generative AI with an emotion estimation function. The generative AI may be a text generative AI (e.g., LLM) or a multimodal generative AI, but is not limited to such examples. Some or all of the above-described processing in the reading unit may be performed using AI or without using AI. For example, the reading unit may input the customer's audio data to a generative AI and have the generative AI perform emotion estimation.

The reading unit may be provided with a function to automatically record the start time and end time of the conversation when reading the conversation content. For example, the reading unit may have AI automatically record the start time at the moment the call begins. In addition, the reading unit may have AI automatically record the end time when the call ends and calculate the total call duration. Furthermore, the reading unit may have AI record the start and end times of the call in real time when reading the conversation content so that they can be referenced later. By automatically recording the start and end times of the call in this way, the total call duration can be accurately grasped. Some or all of the above-described processing in the reading unit may be performed using AI or without using AI. For example, the reading unit may input the start and end times of the call to a generative AI and have the generative AI perform the recording.

The reading unit may be provided with a function to convert the content of the conversation into text in real time when reading the conversation content. For example, the reading unit may have AI convert the conversation content into text in real time and display it immediately. In addition, the reading unit may have AI convert speech into text and record it in real time when reading the conversation content. Furthermore, the reading unit may have AI use speech recognition technology to convert the conversation content into text in real time when reading the conversation content. By converting the conversation content into text in real time in this way, the content can be checked immediately. Some or all of the above-described processing in the reading unit may be performed using AI or without using AI. For example, the reading unit may input audio data of the conversation content to a generative AI and have the generative AI perform the text conversion.

The analysis unit may estimate the customer's emotion and adjust the expression method of the analysis result based on the estimated emotion of the customer. For example, if the customer is feeling anxious, AI may express the analysis result in an easy-to-understand manner that provides reassurance. If the customer is excited, AI may express the analysis result calmly and objectively. In addition, if the customer is relaxed, AI may express the analysis result in detail and with care. By adjusting the expression method of the analysis result according to the customer's emotion in this way, more appropriate analysis results can be provided. Emotion estimation is realized, for example, by using an emotion engine or a generative AI with an emotion estimation function. The generative AI may be a text generative AI (e.g., LLM) or a multimodal generative AI, but is not limited to such examples. Some or all of the above-described processing in the analysis unit may be performed using AI or without using AI. For example, the analysis unit may input the customer's audio data to a generative AI and have the generative AI perform emotion estimation.

The analysis unit may be provided with a function to improve analysis accuracy by considering the context of the conversation content during analysis. For example, the analysis unit may have AI analyze the context of the conversation content and extract important information. In addition, the analysis unit may have AI improve the accuracy of analysis results by considering the context of the conversation content. Furthermore, the analysis unit may have AI understand the context of the conversation content and accurately analyze related information. By considering the context of the conversation content in this way, analysis accuracy is improved. Some or all of the above-described processing in the analysis unit may be performed using AI or without using AI. For example, the analysis unit may input text data of the conversation content to a generative AI and have the generative AI perform context analysis.

The analysis unit may be provided with a function to apply different analysis algorithms according to the category of the conversation content during analysis. For example, if the conversation content is related to complaint handling, the analysis unit may have AI apply a specific analysis algorithm. In addition, if the conversation content is related to inquiry handling, the analysis unit may have AI apply a different analysis algorithm. Furthermore, if the conversation content is related to order reception, the analysis unit may have AI select and apply an appropriate analysis algorithm. By applying appropriate analysis algorithms according to the category of the conversation content in this way, analysis accuracy is improved. Some or all of the above-described processing in the analysis unit may be performed using AI or without using AI. For example, the analysis unit may input text data of the conversation content to a generative AI and have the generative AI perform category-based analysis.

The analysis unit may estimate the customer's emotion and determine the priority of the analysis results based on the estimated emotion of the customer. For example, if the customer is feeling anxious, AI may preferentially display important analysis results based on that emotion. If the customer is excited, AI may preferentially display calm analysis results based on that emotion. In addition, if the customer is relaxed, AI may display the overall analysis results evenly based on that emotion. By determining the priority of the analysis results according to the customer's emotion in this way, important information can be preferentially provided. Emotion estimation is realized, for example, by using an emotion engine or a generative AI with an emotion estimation function. The generative AI may be a text generative AI (e.g., LLM) or a multimodal generative AI, but is not limited to such examples. Some or all of the above-described processing in the analysis unit may be performed using AI or without using AI. For example, the analysis unit may input the customer's audio data to a generative AI and have the generative AI perform emotion estimation.

The analysis unit may be provided with a function to adjust the level of detail of the analysis based on the length of the conversation content during analysis. For example, if the conversation content is short, the analysis unit may have AI perform detailed analysis and extract important information. In addition, if the conversation content is long, the analysis unit may have AI perform an overall analysis and summarize the main points.

Furthermore, the analysis unit may have AI adjust the level of detail of the analysis according to the length of the conversation content and provide appropriate information.

By adjusting the level of detail of the analysis according to the length of the conversation content in this way, appropriate information can be provided. Some or all of the above-described processing in the analysis unit may be performed using AI or without using AI. For example, the analysis unit may input text data of the conversation content to a generative AI and have the generative AI perform length-based analysis.

The analysis unit may be provided with a function to adjust the order of analysis results based on the relevance of the conversation content during analysis. For example, the analysis unit may have AI analyze the relevance of the conversation content and display important information preferentially. In addition, the analysis unit may have AI adjust the order of analysis results based on the relevance of the conversation content. Furthermore, the analysis unit may have AI understand the relevance of the conversation content and display analysis results in an appropriate order. By adjusting the order of analysis results based on the relevance of the conversation content in this way, important information can be provided preferentially. Some or all of the above-described processing in the analysis unit may be performed using AI or without using AI. For example, the analysis unit may input text data of the conversation content to a generative AI and have the generative AI perform relevance-based analysis.

The matching unit can estimate the customer's emotion and adjust the matching criteria based on the estimated emotion of the customer. For example, when the customer is feeling anxious, the AI can set the matching criteria strictly to prevent mistakes. In addition, when the customer is relaxed, the AI can set the matching criteria flexibly, placing emphasis on a natural response.

Furthermore, when the customer is in a hurry, the AI can set the matching criteria quickly to provide an efficient response. By adjusting the matching criteria according to the customer's emotion in this manner, more accurate matching becomes possible. The estimation of emotion is realized, for example, by using an emotion estimation function employing an emotion engine or generative AI. The generative AI may be a text-generating AI (for example, an LLM) or a multimodal generative AI, but is not limited to such examples. Some or all of the above-described processing in the matching unit may be performed using AI, or may be performed without using AI. For example, the matching unit can input the customer's voice data to the generative AI and have the generative AI perform the emotion estimation.

The matching unit may be provided with a function to improve matching accuracy by considering the change history of PC screen information during matching. For example, the matching unit may have AI analyze the change history of PC screen information and improve matching accuracy. In addition, the matching unit may have AI consider the change history of PC screen information during matching and perform accurate matching. Furthermore, the matching unit may have AI learn the change history of PC screen information and improve matching accuracy. By considering the change history of PC screen information in this way, matching accuracy is improved. Some or all of the above-described processing in the matching unit may be performed using AI or without using AI. For example, the matching unit may input change history data of PC screen information to a generative AI and have the generative AI perform matching accuracy improvement.

The matching unit may be provided with a function to apply different matching algorithms according to the category of PC screen information during matching. For example, if the PC screen information is customer information, the matching unit may have AI apply a specific matching algorithm. In addition, if the PC screen information is order information, the matching unit may have AI apply a different matching algorithm. Furthermore, if the PC screen information is inquiry information, the matching unit may have AI select and apply an appropriate matching algorithm. By applying appropriate matching algorithms according to the category of PC screen information in this way, matching accuracy is improved. Some or all of the above-described processing in the matching unit may be performed using AI or without using AI. For example, the matching unit may input data of PC screen information to a generative AI and have the generative AI perform category-based matching.

The matching unit may estimate the customer's emotion and adjust the display order of matching results based on the estimated emotion of the customer. For example, if the customer is feeling anxious, AI may preferentially display important matching results. If the customer is relaxed, AI may display the overall matching results evenly. In addition, if the customer is in a hurry, AI may display matching results quickly. By adjusting the display order of matching results according to the customer's emotion in this way, important information can be preferentially displayed. Emotion estimation is realized, for example, by using an emotion engine or a generative AI with an emotion estimation function. The generative AI may be a text generative AI (e.g., LLM) or a multimodal generative AI, but is not limited to such examples. Some or all of the above-described processing in the matching unit may be performed using AI or without using AI. For example, the matching unit may input the customer's audio data to a generative AI and have the generative AI perform emotion estimation.

The matching unit may be provided with a function to determine the priority of matching based on the update frequency of PC screen information during matching. For example, the matching unit may have AI analyze the update frequency of PC screen information and determine the priority of matching. In addition, the matching unit may have AI consider the update frequency of PC screen information during matching and preferentially match important information. Furthermore, the matching unit may have AI adjust the priority of matching based on the update frequency of PC screen information. By determining the priority of matching based on the update frequency of PC screen information in this way, important information can be preferentially matched. Some or all of the above-described processing in the matching unit may be performed using AI or without using AI. For example, the matching unit may input update frequency data of PC screen information to a generative AI and have the generative AI perform priority determination.

The matching unit may be provided with a function to adjust the order of matching results based on the relevance of PC screen information during matching. For example, the matching unit may have AI analyze the relevance of PC screen information and preferentially match important information. In addition, the matching unit may have AI consider the relevance of PC screen information during matching and adjust the order of matching results. Furthermore, the matching unit may have AI display matching results in an appropriate order based on the relevance of PC screen information. By adjusting the order of matching results based on the relevance of PC screen information in this way, important information can be displayed preferentially. Some or all of the above-described processing in the matching unit may be performed using AI or without using AI. For example, the matching unit may input relevance data of PC screen information to a generative AI and have the generative AI perform order adjustment.

The warning unit may estimate the customer's emotion and adjust the display method of warnings based on the estimated emotion of the customer. For example, if the customer is feeling anxious, AI may display warnings in an easy-to-understand manner that provides reassurance. If the customer is excited, AI may display warnings calmly and objectively. In addition, if the customer is relaxed, AI may display warnings in detail and with care. By adjusting the display method of warnings according to the customer's emotion in this way, more appropriate warnings can be provided. Emotion estimation is realized, for example, by using an emotion engine or a generative AI with an emotion estimation function. The generative AI may be a text generative AI (e.g., LLM) or a multimodal generative AI, but is not limited to such examples. Some or all of the above-described processing in the warning unit may be performed using AI or without using AI. For example, the warning unit may input the customer's audio data to a generative AI and have the generative AI perform emotion estimation.

The warning unit may be provided with a function to improve the accuracy of warnings by referring to past warning histories during warning. For example, the warning unit may have AI analyze past warning histories and improve the accuracy of warnings. In addition, the warning unit may have AI refer to past warning histories during warning and issue accurate warnings. Furthermore, the warning unit may have AI learn past warning histories and improve the accuracy of warnings. By referring to past warning histories in this way, the accuracy of warnings is improved. Some or all of the above-described processing in the warning unit may be performed using AI or without using AI. For example, the warning unit may input past warning history data to a generative AI and have the generative AI perform accuracy improvement.

The warning unit may be provided with a function to apply different warning means according to the importance of the warning during warning. For example, in the case of a highly important warning, the warning unit may have AI issue both audio and visual warnings simultaneously. In addition, in the case of a less important warning, the warning unit may have AI issue only a visual warning. Furthermore, the warning unit may have AI select appropriate warning means according to the importance and issue warnings. By selecting appropriate warning means according to the importance of the warning in this way, effective warnings can be provided. Some or all of the above-described processing in the warning unit may be performed using AI or without using AI. For example, the warning unit may input importance data of the warning to a generative AI and have the generative AI perform means selection.

The warning unit may estimate the customer's emotion and determine the priority of warnings based on the estimated emotion of the customer. For example, if the customer is feeling anxious, AI may preferentially display important warnings based on that emotion. If the customer is excited, AI may preferentially display calm warnings based on that emotion. In addition, if the customer is relaxed, AI may display overall warnings evenly based on that emotion. By determining the priority of warnings according to the customer's emotion in this way, important warnings can be preferentially displayed. Emotion estimation is realized, for example, by using an emotion engine or a generative AI with an emotion estimation function. The generative AI may be a text generative AI (e.g., LLM) or a multimodal generative AI, but is not limited to such examples. Some or all of the above-described processing in the warning unit may be performed using AI or without using AI. For example, the warning unit may input the customer's audio data to a generative AI and have the generative AI perform emotion estimation.

The warning unit may be provided with a function to adjust the display order of warnings based on the frequency of warning occurrences during warning. For example, the warning unit may have AI analyze the frequency of warning occurrences and preferentially display important warnings. In addition, the warning unit may have AI consider the frequency of warning occurrences during warning and preferentially display important information. Furthermore, the warning unit may have AI adjust the display order of warnings based on the frequency of warning occurrences. By adjusting the display order of warnings based on the frequency of warning occurrences in this way, important information can be displayed preferentially. Some or all of the above-described processing in the warning unit may be performed using AI or without using AI. For example, the warning unit may input frequency data of warning occurrences to a generative AI and have the generative AI perform order adjustment.

The warning unit may be provided with a function to adjust the order of warning contents based on the relevance of warnings during warning. For example, the warning unit may have AI analyze the relevance of warnings and preferentially display important information. In addition, the warning unit may have AI consider the relevance of warnings during warning and adjust the order of warning contents. Furthermore, the warning unit may have AI display warning contents in an appropriate order based on the relevance of warnings. By adjusting the order of warning contents based on the relevance of warnings in this way, important information can be displayed preferentially. Some or all of the above-described processing in the warning unit may be performed using AI or without using AI. For example, the warning unit may input relevance data of warnings to a generative AI and have the generative AI perform order adjustment.

The customer service reading unit may estimate the customer's emotion and adjust the reading accuracy of customer service content based on the estimated emotion of the customer. For example, if the customer is nervous, AI may adjust the tone and speed of the voice to improve the reading accuracy of customer service content. If the customer is relaxed, AI may focus on the natural flow of conversation while maintaining the reading accuracy of customer service content. In addition, if the customer is in a hurry, AI may adjust to prioritize reading important parts of the customer service content. By adjusting the reading accuracy of customer service content according to the customer's emotion in this way, more accurate information can be obtained. Emotion estimation is realized, for example, by using an emotion engine or a generative AI with an emotion estimation function. The generative AI may be a text generative AI (e.g., LLM) or a multimodal generative AI, but is not limited to such examples. Some or all of the above-described processing in the customer service reading unit may be performed using AI or without using AI. For example, the customer service reading unit may input the customer's audio data to a generative AI and have the generative AI perform emotion estimation.

The customer service reading unit may be provided with a filtering function to remove background sounds and noise when reading customer service content. For example, the customer service reading unit analyzes background sounds occurring during customer service in real time, and AI removes noise to clearly read the customer service content. In addition, the customer service reading unit may filter noise in specific frequency bands when reading customer service content, allowing AI to extract important audio information. Furthermore, the customer service reading unit may have AI learn environmental sounds and automatically remove specific noise patterns when reading customer service content. By removing background sounds and noise in this way, the customer service content can be read clearly. Some or all of the above-described processing in the customer service reading unit may be performed using AI or without using AI. For example, the customer service reading unit may input audio data during customer service to a generative AI and have the generative AI perform noise removal.

The customer service reading unit may be provided with a function to emphasize and read specific keywords or phrases when reading customer service content. For example, the customer service reading unit may have AI automatically detect important keywords in the customer service content and emphasize them when reading. In addition, the customer service reading unit may have AI preferentially extract specific phrases and emphasize them according to their importance when reading customer service content. Furthermore, the customer service reading unit may have AI emphasize important information based on a preset keyword list when reading customer service content. By emphasizing and reading important keywords or phrases in this way, important information is not overlooked. Some or all of the above-described processing in the customer service reading unit may be performed using AI or without using AI. For example, the customer service reading unit may input audio data of the customer service content to a generative AI and have the generative AI perform the emphasis of keywords or phrases.

The customer service reading unit may estimate the customer's emotion and determine the priority of customer service content to be read based on the estimated emotion of the customer. For example, if the customer is feeling anxious, AI may prioritize reading important customer service content based on that emotion. If the customer is excited, AI may prioritize reading the calm parts of the customer service content based on that emotion. In addition, if the customer is calm, AI may read the entire customer service content evenly based on that emotion. By determining the priority of customer service content according to the customer's emotion in this way, important information can be preferentially obtained. Emotion estimation is realized, for example, by using an emotion engine or a generative AI with an emotion estimation function. The generative AI may be a text generative AI (e.g., LLM) or a multimodal generative AI, but is not limited to such examples. Some or all of the above-described processing in the customer service reading unit may be performed using AI or without using AI. For example, the customer service reading unit may input the customer's audio data to a generative AI and have the generative AI perform emotion estimation.

The customer service reading unit may be provided with a function to automatically record the start time and end time of customer service when reading customer service content. For example, the customer service reading unit may have AI automatically record the start time at the moment customer service begins. In addition, the customer service reading unit may have AI automatically record the end time when customer service ends and calculate the total customer service duration. Furthermore, the customer service reading unit may have AI record the start and end times of customer service in real time when reading customer service content so that they can be referenced later. By automatically recording the start and end times of customer service in this way, the total customer service duration can be accurately grasped. Some or all of the above-described processing in the customer service reading unit may be performed using AI or without using AI. For example, the customer service reading unit may input the start and end times of customer service to a generative AI and have the generative AI perform the recording.

The customer service reading unit may be provided with a function to convert the content of customer service into text in real time when reading customer service content. For example, the customer service reading unit may have AI convert the customer service content into text in real time and display it immediately. In addition, the customer service reading unit may have AI convert speech into text and record it in real time when reading customer service content. Furthermore, the customer service reading unit may have AI use speech recognition technology to convert the customer service content into text in real time when reading customer service content. By converting the customer service content into text in real time in this way, the content can be checked immediately. Some or all of the above-described processing in the customer service reading unit may be performed using AI or without using AI. For example, the customer service reading unit may input audio data of the customer service content to a generative AI and have the generative AI perform the text conversion.

The system according to the embodiment is not limited to the above-described examples and can be variously modified as follows, for example.

The analysis unit may improve analysis accuracy by considering the context of the conversation content during analysis. For example, the analysis unit may have AI analyze the context of the conversation content and extract important information. In addition, the analysis unit may have AI improve the accuracy of analysis results by considering the context of the conversation content. Furthermore, the analysis unit may have AI understand the context of the conversation content and accurately analyze related information. By considering the context of the conversation content in this way, analysis accuracy is improved. Some or all of the above-described processing in the analysis unit may be performed using AI or without using AI. For example, the analysis unit may input text data of the conversation content to a generative AI and have the generative AI perform context analysis.

The warning unit may improve the accuracy of warnings by referring to past warning histories during warning. For example, the warning unit may have AI analyze past warning histories and improve the accuracy of warnings. In addition, the warning unit may have AI refer to past warning histories during warning and issue accurate warnings. Furthermore, the warning unit may have AI learn past warning histories and improve the accuracy of warnings. By referring to past warning histories in this way, the accuracy of warnings is improved. Some or all of the above-described processing in the warning unit may be performed using AI or without using AI. For example, the warning unit may input past warning history data to a generative AI and have the generative AI perform accuracy improvement.

The matching unit may improve matching accuracy by considering the change history of PC screen information during matching. For example, the matching unit may have AI analyze the change history of PC screen information and improve matching accuracy. In addition, the matching unit may have AI consider the change history of PC screen information during matching and perform accurate matching. Furthermore, the matching unit may have AI learn the change history of PC screen information and improve matching accuracy. By considering the change history of PC screen information in this way, matching accuracy is improved.

Some or all of the above-described processing in the matching unit may be performed using AI or without using AI. For example, the matching unit may input change history data of PC screen information to a generative AI and have the generative AI perform matching accuracy improvement.

The reading unit may be provided with a filtering function to remove background sounds and noise when reading the conversation content. For example, the reading unit analyzes background sounds occurring during a call in real time, and AI removes noise to clearly read the conversation content. In addition, the reading unit may filter noise in specific frequency bands when reading the conversation content, allowing AI to extract important audio information. Furthermore, the reading unit may have AI learn environmental sounds and automatically remove specific noise patterns when reading the conversation content. By removing background sounds and noise in this way, the conversation content can be read clearly. Some or all of the above-described processing in the reading unit may be performed using AI or without using AI. For example, the reading unit may input audio data during a call to a generative AI and have the generative AI perform noise removal.

The analysis unit may adjust the level of detail of the analysis based on the length of the conversation content during analysis. For example, if the conversation content is short, the analysis unit may have AI perform detailed analysis and extract important information. In addition, if the conversation content is long, the analysis unit may have AI perform an overall analysis and summarize the main points. Furthermore, the analysis unit may have AI adjust the level of detail of the analysis according to the length of the conversation content and provide appropriate information. By adjusting the level of detail of the analysis according to the length of the conversation content in this way, appropriate information can be provided. Some or all of the above-described processing in the analysis unit may be performed using AI or without using AI. For example, the analysis unit may input text data of the conversation content to a generative AI and have the generative AI perform length-based analysis.

The reading unit may estimate the customer's emotion and adjust the reading accuracy of the conversation content based on the estimated emotion of the customer. For example, if the customer is nervous, AI may adjust the tone and speed of the voice to improve the reading accuracy of the conversation content. If the customer is relaxed, AI may focus on the natural flow of conversation while maintaining the reading accuracy of the conversation content. Furthermore, if the customer is in a hurry, AI may adjust to prioritize reading important parts of the conversation content. By adjusting the reading accuracy of the conversation content according to the customer's emotion in this way, more accurate information can be obtained. Emotion estimation is realized, for example, by using an emotion engine or a generative AI with an emotion estimation function. The generative AI may be a text generative AI (e.g., LLM) or a multimodal generative AI, but is not limited to such examples. Some or all of the above-described processing in the reading unit may be performed using AI or without using AI. For example, the reading unit may input the customer's audio data to a generative AI and have the generative AI perform emotion estimation.

The analysis unit may estimate the customer's emotion and adjust the expression method of the analysis result based on the estimated emotion of the customer. For example, if the customer is feeling anxious, AI may express the analysis result in an easy-to-understand manner that provides reassurance. If the customer is excited, AI may express the analysis result calmly and objectively. Furthermore, if the customer is relaxed, AI may express the analysis result in detail and with care. By adjusting the expression method of the analysis result according to the customer's emotion in this way, more appropriate analysis results can be provided. Emotion estimation is realized, for example, by using an emotion engine or a generative AI with an emotion estimation function. The generative AI may be a text generative AI (e.g., LLM) or a multimodal generative AI, but is not limited to such examples. Some or all of the above-described processing in the analysis unit may be performed using AI or without using AI. For example, the analysis unit may input the customer's audio data to a generative AI and have the generative AI perform emotion estimation.

The matching unit may estimate the customer's emotion and adjust the matching criteria based on the estimated emotion of the customer. For example, if the customer is feeling anxious, AI may set strict matching criteria to prevent mistakes. If the customer is relaxed, AI may set flexible matching criteria and focus on natural responses. Furthermore, if the customer is in a hurry, AI may set matching criteria quickly and respond efficiently. By adjusting the matching criteria according to the customer's emotion in this way, more accurate matching is possible.

Emotion estimation is realized, for example, by using an emotion engine or a generative AI with an emotion estimation function. The generative AI may be a text generative AI (e.g., LLM) or a multimodal generative AI, but is not limited to such examples. Some or all of the above-described processing in the matching unit may be performed using AI or without using AI. For example, the matching unit may input the customer's audio data to a generative AI and have the generative AI perform emotion estimation.

The warning unit may estimate the customer's emotion and adjust the display method of warnings based on the estimated emotion of the customer. For example, if the customer is feeling anxious, AI may display warnings in an easy-to-understand manner that provides reassurance. If the customer is excited, AI may display warnings calmly and objectively. Furthermore, if the customer is relaxed, AI may display warnings in detail and with care. By adjusting the display method of warnings according to the customer's emotion in this way, more appropriate warnings can be provided. Emotion estimation is realized, for example, by using an emotion engine or a generative AI with an emotion estimation function. The generative AI may be a text generative AI (e.g., LLM) or a multimodal generative AI, but is not limited to such examples. Some or all of the above-described processing in the warning unit may be performed using AI or without using AI. For example, the warning unit may input the customer's audio data to a generative AI and have the generative AI perform emotion estimation.

The customer service reading unit may estimate the customer's emotion and adjust the reading accuracy of customer service content based on the estimated emotion of the customer. For example, if the customer is nervous, AI may adjust the tone and speed of the voice to improve the reading accuracy of customer service content. If the customer is relaxed, AI may focus on the natural flow of conversation while maintaining the reading accuracy of customer service content. Furthermore, if the customer is in a hurry, AI may adjust to prioritize reading important parts of the customer service content. By adjusting the reading accuracy of customer service content according to the customer's emotion in this way, more accurate information can be obtained. Emotion estimation is realized, for example, by using an emotion engine or a generative AI with an emotion estimation function. The generative AI may be a text generative AI (e.g., LLM) or a multimodal generative AI, but is not limited to such examples. Some or all of the above-described processing in the customer service reading unit may be performed using AI or without using AI. For example, the customer service reading unit may input the customer's audio data to a generative AI and have the generative AI perform emotion estimation.

A brief description of the processing flow of Example 2 of the Embodiment is provided below.

Step 1: The reading unit reads the content of conversations with customers. The reading unit can read, for example, the content of voice calls, video calls, or text chats. Step 2: The analysis unit analyzes the conversation content read by the reading unit. The analysis unit can analyze the conversation content by methods such as speech recognition, emotion analysis, or keyword extraction. Step 3: The matching unit compares the PC screen information registered by crew members. The matching unit can perform matching based on criteria such as matching rate or similarity calculation with a database.

Step 4: The warning unit issues a warning when a difference occurs based on the information matched by the matching unit. The warning unit can display warnings by methods such as pop-up notifications or voice alerts. Step 5: The customer service reading unit reads the content of customer service at the storefront. The customer service reading unit can read, for example, the content of face-to-face service, online service, or chat support.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL:https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the above-described reading unit, analysis unit, matching unit, warning unit, and customer service reading unit is implemented, for example, by at least one of the smart device 14 and the data processing apparatus 12. For example, the reading unit can read conversation content using the microphone 38B or camera 42 of the smart device 14. The analysis unit is implemented, for example, by a specific processing unit 290 of the data processing apparatus 12 and performs speech recognition and emotion analysis. The matching unit is implemented, for example, by the specific processing unit 290 of the data processing apparatus 12 and calculates the matching rate or similarity with PC screen information. The warning unit is implemented, for example, by the control unit 46A of the smart device 14 and displays pop-up notifications or voice alerts. The customer service reading unit can read the content of customer service at the storefront using, for example, the camera 42 or microphone 38B of the smart device 14. The correspondence between each unit and the device or control unit is not limited to the above examples and various modifications are possible.

### Second Embodiment

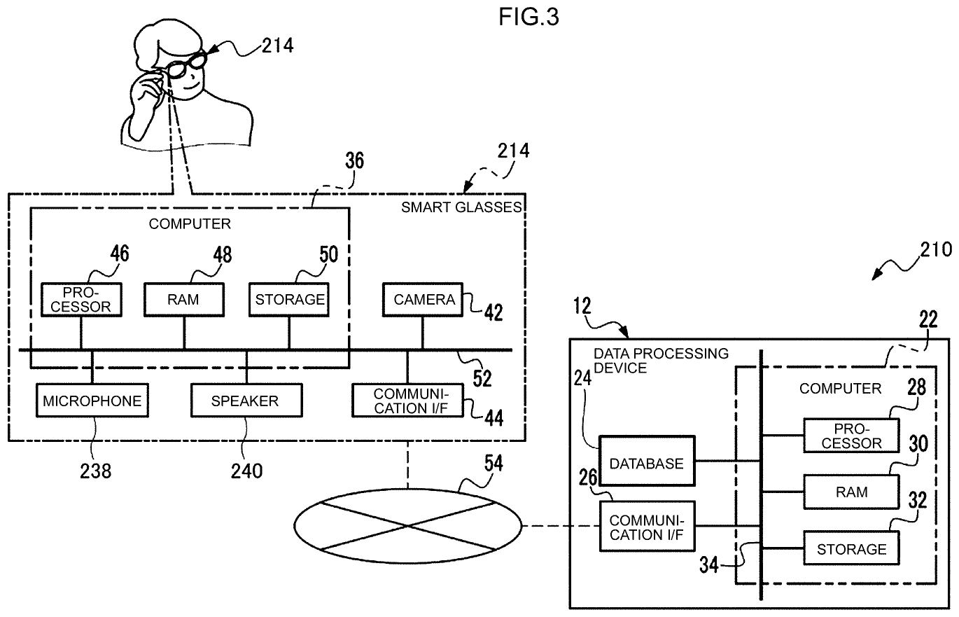

FIG. 3 shows an example configuration of a data processing system 210 according to the second embodiment.

As shown in FIG. 3, the data processing system 210 includes a data processing device 12 and smart glasses 214. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 includes a computer 36, a microphone 238, a speaker 240, a camera 42, and a communication I/F 44. The computer 36 includes a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

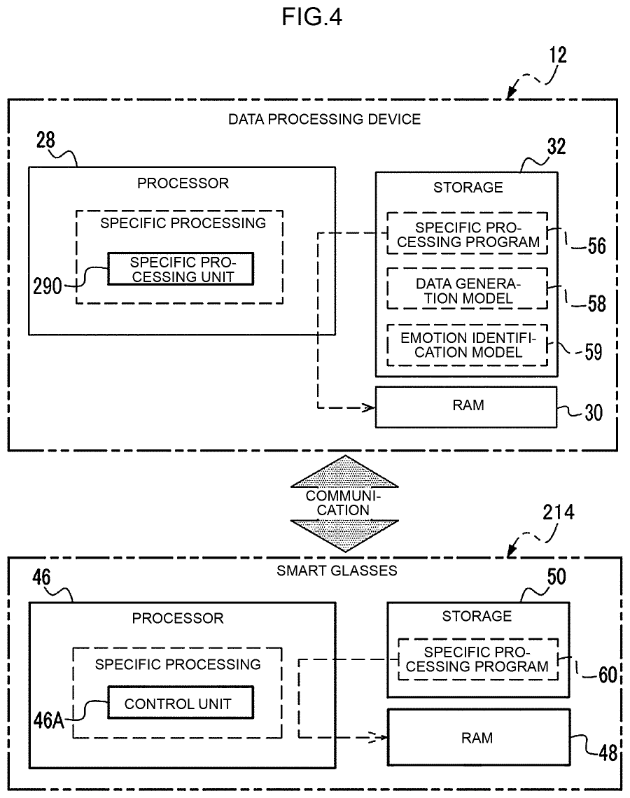

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the above-described reading unit, analysis unit, matching unit, warning unit, and customer service reading unit is implemented, for example, by at least one of the smart glasses 214 and the data processing apparatus 12. For example, the reading unit can read conversation content using the microphone 238 or camera 42 of the smart glasses 214. The analysis unit is implemented, for example, by a specific processing unit 290 of the data processing apparatus 12 and performs speech recognition and emotion analysis. The matching unit is implemented, for example, by the specific processing unit 290 of the data processing apparatus 12 and calculates the matching rate or similarity with PC screen information. The warning unit is implemented, for example, by the control unit 46A of the smart glasses 214 and displays pop-up notifications or voice alerts. The customer service reading unit can read the content of customer service at the storefront using, for example, the camera 42 or microphone 238 of the smart glasses 214. The correspondence between each unit and the device or control unit is not limited to the above examples and various modifications are possible.

### Third Embodiment

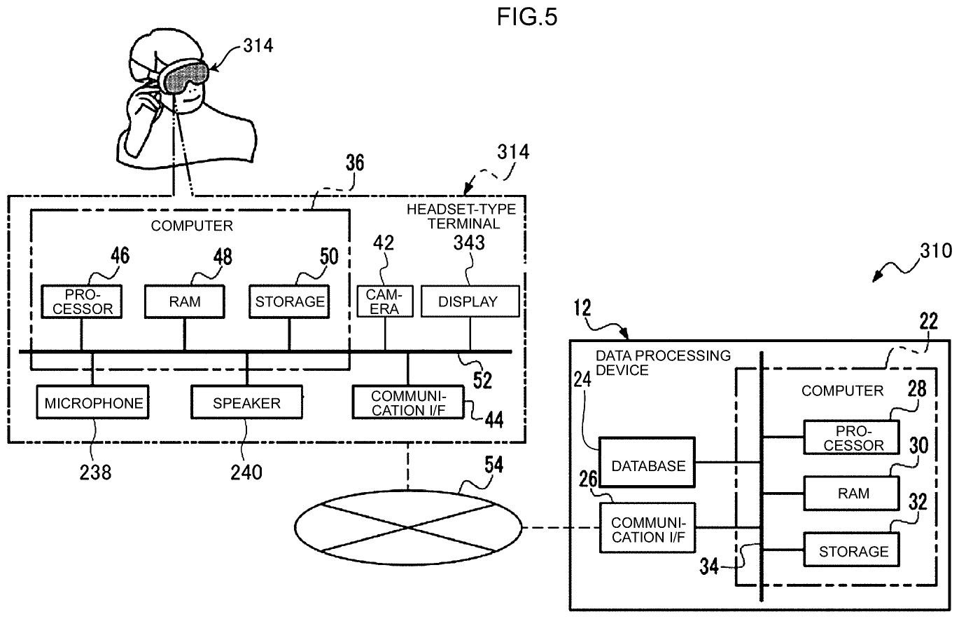

FIG. 5 shows an example configuration of a data processing system 310 according to the third embodiment.

As shown in FIG. 5, the data processing system 310 includes a data processing device 12 and a headset-type terminal 314. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 includes a computer 36, a microphone 238, a speaker 240, a camera 42, a communication I/F 44, and a display 343. The computer 36 includes a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

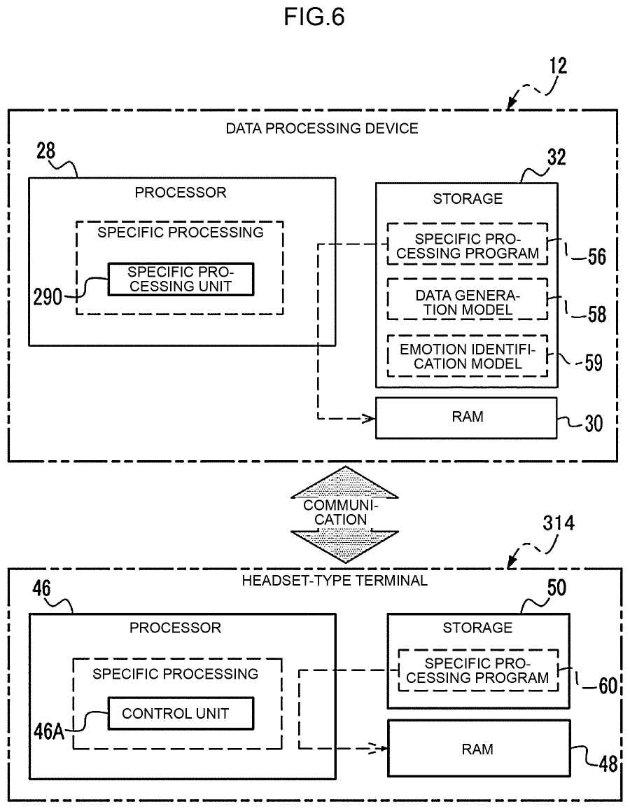

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent.

Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the above-described reading unit, analysis unit, matching unit, warning unit, and customer service reading unit is implemented, for example, by at least one of the headset-type terminal 314 and the data processing apparatus 12. For example, the reading unit can read conversation content using the microphone 238 or camera 42 of the headset-type terminal 314. The analysis unit is implemented, for example, by a specific processing unit 290 of the data processing apparatus 12 and performs speech recognition and emotion analysis. The matching unit is implemented, for example, by the specific processing unit 290 of the data processing apparatus 12 and calculates the matching rate or similarity with PC screen information. The warning unit is implemented, for example, by the control unit 46A of the headset-type terminal 314 and displays pop-up notifications or voice alerts. The customer service reading unit can read the content of customer service at the storefront using, for example, the camera 42 or microphone 238 of the headset-type terminal 314. The correspondence between each unit and the device or control unit is not limited to the above examples and various modifications are possible.

### Fourth Embodiment

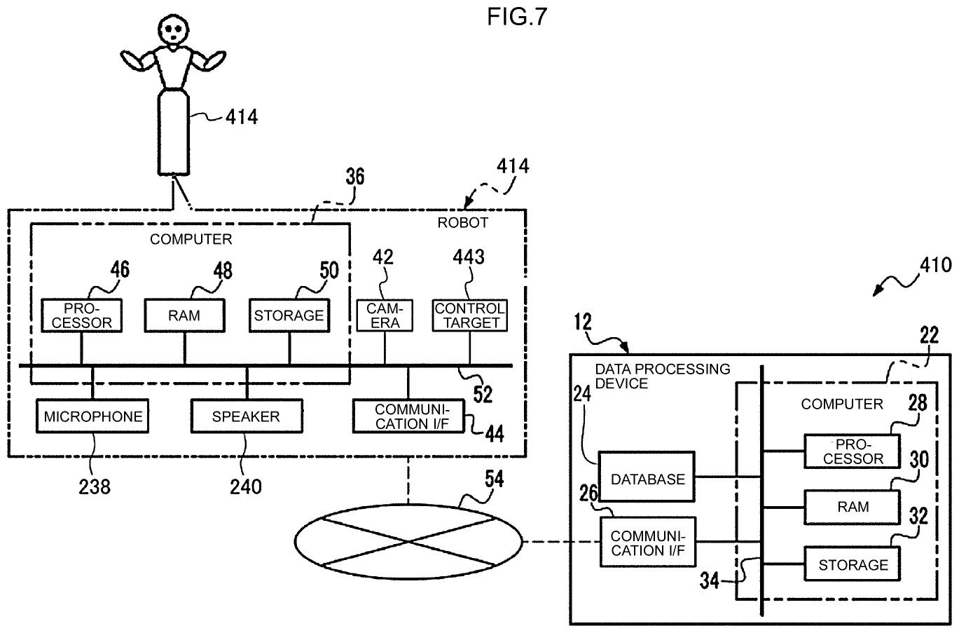

FIG. 7 shows an example configuration of a data processing system 410 according to the fourth embodiment.

As shown in FIG. 7, the data processing system 410 includes a data processing device 12 and a robot 414. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 includes a computer 36, a microphone 238, a speaker 240, a camera 42, a communication I/F 44, and a control target 443. The computer 36 includes a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

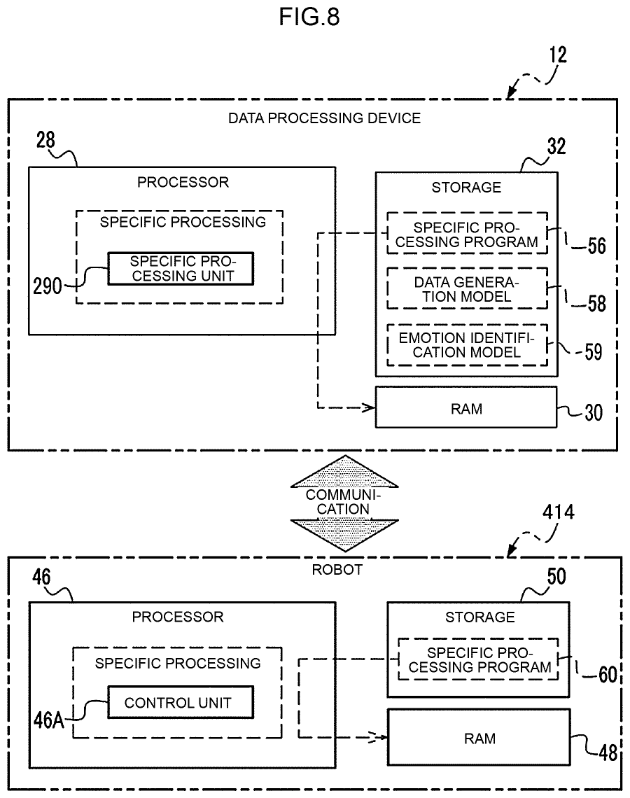

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the above-described reading unit, analysis unit, matching unit, warning unit, and customer service reading unit is implemented, for example, by at least one of the robot 414 and the data processing apparatus 12. For example, the reading unit can read conversation content using the microphone 238 or camera 42 of the robot 414. The analysis unit is implemented, for example, by a specific processing unit 290 of the data processing apparatus 12 and performs speech recognition and emotion analysis. The matching unit is implemented, for example, by the specific processing unit 290 of the data processing apparatus 12 and calculates the matching rate or similarity with PC screen information. The warning unit is implemented, for example, by the control unit 46A of the robot 414 and displays pop-up notifications or voice alerts. The customer service reading unit can read the content of customer service at the storefront using, for example, the camera 42 or microphone 238 of the robot 414. The correspondence between each unit and the device or control unit is not limited to the above examples and various modifications are possible.

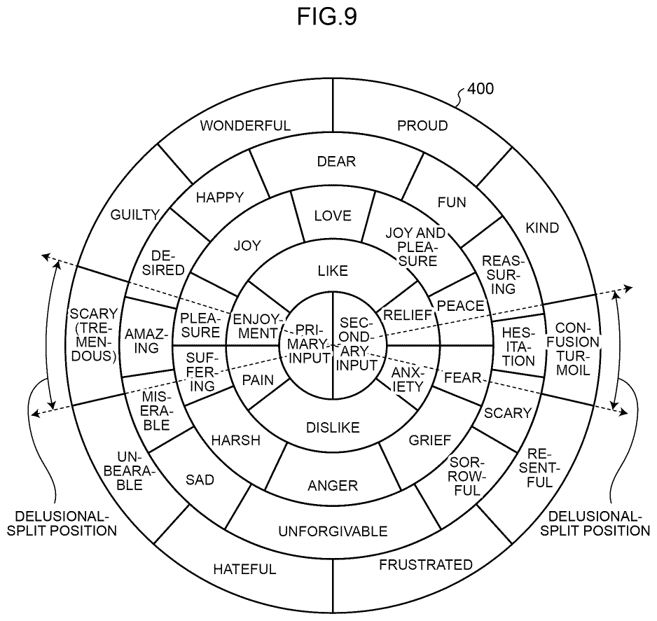

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

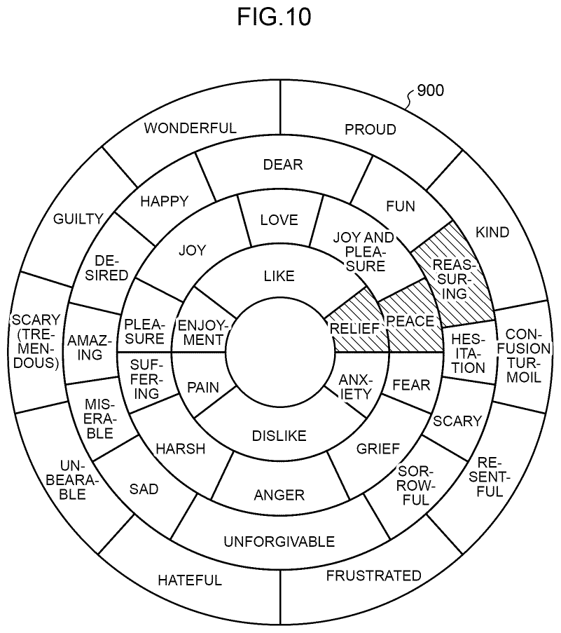

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used. Additionally, the examples described above were explained by dividing into form example 1 and form example 2, but these may be combined.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

[Additional Note 1] A system including: a reading unit configured to read the content of conversations with customers; an analysis unit configured to analyze the conversation content read by the reading unit; a matching unit configured to compare the PC screen information registered by crew members; a warning unit configured to issue a warning when a difference occurs based on the information matched by the matching unit; and a customer service reading unit configured to read the content of customer service at the storefront.

[Additional Note 2] The system according to Additional Note 1, wherein the reading unit is configured to estimate the customer's emotion and adjust the reading accuracy of the conversation content based on the estimated emotion of the customer.

[Additional Note 3] The system according to Additional Note 1, wherein the reading unit is provided with a filtering function to remove background sounds and noise when reading the conversation content.

[Additional Note 4] The system according to Additional Note 1, wherein the reading unit is provided with a function to emphasize and read specific keywords or phrases when reading the conversation content.

[Additional Note 5] The system according to Additional Note 1, wherein the reading unit is configured to estimate the customer's emotion and determine the priority of the conversation content to be read based on the estimated emotion of the customer.

[Additional Note 6] The system according to Additional Note 1, wherein the reading unit is provided with a function to automatically record the start time and end time of the conversation when reading the conversation content.

[Additional Note 7] The system according to Additional Note 1, wherein the reading unit is provided with a function to convert the content of the conversation into text in real time when reading the conversation content.

[Additional Note 8] The system according to Additional Note 1, wherein the analysis unit is configured to estimate the customer's emotion and adjust the expression method of the analysis result based on the estimated emotion of the customer.

[Additional Note 9] The system according to Additional Note 1, wherein the analysis unit is provided with a function to improve analysis accuracy by considering the context of the conversation content during analysis.

[Additional Note 10] The system according to Additional Note 1, wherein the analysis unit is provided with a function to apply different analysis algorithms according to the category of the conversation content during analysis.

[Additional Note 11] The system according to Additional Note 1, wherein the analysis unit is configured to estimate the customer's emotion and determine the priority of the analysis results based on the estimated emotion of the customer.

[Additional Note 12] The system according to Additional Note 1, wherein the analysis unit is provided with a function to adjust the level of detail of the analysis based on the length of the conversation content during analysis.

[Additional Note 13] The system according to Additional Note 1, wherein the analysis unit is provided with a function to adjust the order of analysis results based on the relevance of the conversation content during analysis.

[Additional Note 14] The system according to Additional Note 1, wherein the matching unit is configured to estimate the customer's emotion and adjust the matching criteria based on the estimated emotion of the customer.

[Additional Note 15] The system according to Additional Note 1, wherein the matching unit is provided with a function to improve matching accuracy by considering the change history of PC screen information during matching.

[Additional Note 16] The system according to Additional Note 1, wherein the matching unit is provided with a function to apply different matching algorithms according to the category of PC screen information during matching.

[Additional Note 17] The system according to Additional Note 1, wherein the matching unit is configured to estimate the customer's emotion and adjust the display order of matching results based on the estimated emotion of the customer.

[Additional Note 18] The system according to Additional Note 1, wherein the matching unit is provided with a function to determine the priority of matching based on the update frequency of PC screen information during matching.

[Additional Note 19] The system according to Additional Note 1, wherein the matching unit is provided with a function to adjust the order of matching results based on the relevance of PC screen information during matching.

[Additional Note 20] The system according to Additional Note 1, wherein the warning unit is configured to estimate the customer's emotion and adjust the display method of warnings based on the estimated emotion of the customer.

[Additional Note 21] The system according to Additional Note 1, wherein the warning unit is provided with a function to improve the accuracy of warnings by referring to past warning histories during warning.

[Additional Note 22] The system according to Additional Note 1, wherein the warning unit is provided with a function to apply different warning means according to the importance of the warning during warning.

[Additional Note 23] The system according to Additional Note 1, wherein the warning unit is configured to estimate the customer's emotion and determine the priority of warnings based on the estimated emotion of the customer.

[Additional Note 24] The system according to Additional Note 1, wherein the warning unit is provided with a function to adjust the display order of warnings based on the frequency of warning occurrences during warning.

[Additional Note 25] The system according to Additional Note 1, wherein the warning unit is provided with a function to adjust the order of warning contents based on the relevance of warnings during warning.

[Additional Note 26] The system according to Additional Note 1, wherein the customer service reading unit is configured to estimate the customer's emotion and adjust the reading accuracy of customer service content based on the estimated emotion of the customer.

[Additional Note 27] The system according to Additional Note 1, wherein the customer service reading unit is provided with a filtering function to remove background sounds and noise when reading customer service content.

[Additional Note 28] The system according to Additional Note 1, wherein the customer service reading unit is provided with a function to emphasize and read specific keywords or phrases when reading customer service content.

[Additional Note 29] The system according to Additional Note 1, wherein the customer service reading unit is configured to estimate the customer's emotion and determine the priority of customer service content to be read based on the estimated emotion of the customer.

[Additional Note 30] The system according to Additional Note 1, wherein the customer service reading unit is provided with a function to automatically record the start time and end time of customer service when reading customer service content.

[Additional Note 31] The system according to Additional Note 1, wherein the customer service reading unit is provided with a function to convert the content of customer service into text in real time when reading customer service content.

What is claimed is:

1. A system comprising: a reading unit configured to read the content of conversations with customers; an analysis unit configured to analyze the conversation content read by the reading unit; a matching unit configured to compare the PC screen information registered by crew members; a warning unit configured to issue a warning when a difference occurs based on the information matched by the matching unit; and a customer service reading unit configured to read the content of customer service at the storefront.

2. The system according to claim 1, wherein the reading unit is configured to estimate the customer's emotion and adjust the reading accuracy of the conversation content based on the estimated emotion of the customer.

3. The system according to claim 1, wherein the reading unit is provided with a filtering function to remove background sounds and noise when reading the conversation content.

4. The system according to claim 1, wherein the reading unit is provided with a function to emphasize and read specific keywords or phrases when reading the conversation content.

5. The system according to claim 1, wherein the reading unit is configured to estimate the customer's emotion and determine the priority of the conversation content to be read based on the estimated emotion of the customer.

6. The system according to claim 1, wherein the reading unit is provided with a function to automatically record the start time and end time of the conversation when reading the conversation content.

7. The system according to claim 1, wherein the reading unit is provided with a function to convert the content of the conversation into text in real time when reading the conversation content.

8. The system according to claim 1, wherein the analysis unit is configured to estimate the customer's emotion and adjust the expression method of the analysis result based on the estimated emotion of the customer.

9. The system according to claim 1, wherein the analysis unit is provided with a function to improve analysis accuracy by considering the context of the conversation content during analysis.

10. The system according to claim 1, wherein the analysis unit is provided with a function to apply different analysis algorithms according to the category of the conversation content during analysis.
